(19) United States
(12) Patent Application Publication
(10) Pub. No.: US 2003/0130996 A1
(43) Pub. Date: Jul. 10, 2003

(54) Interactive mining of time series data

(75) Inventors: Stephan Bayerl, Muenchen (DE); Timo Kussmaul, Boeblingen (DE)

Correspondence Address: Samuel A. Kassatly, 6819 Trinidad Drive, San Jose, CA, 95120, US

(73) Assignee: International Business Machines Corporation, Armonk, NY

(21) Appl. No.: 10/317,785

(22) Filed: Dec. 11, 2002

(30) Foreign Application Priority Data
Dec. 21, 2001 (EP) EP 01 130753.5

(51) Int. Cl. G06F 7/00

(52) U.S. Cl. 707/3

(57) ABSTRACT

A system, a computer program produce, and an associated method for the interactive mining of time series or sequence data detect data subsequences in one or more numerical data series, that are identical or similar to a given search pattern. In order to achieve more flexibility of data analysis the system provides a graphical user interface for interactively incorporating subsidiary search patterns into a current definition of similarity. The subsidiary search patterns may be part of the data series under analysis or may be defined by the user. Thus, an iterative procedure for data mining is established for progressively improving the search result that explicitly comprises the features defined by the user.

### PRIORITY CLAIM

The present application claims the priority of European Patent Application No. 01130753.5, titled “Interactive Mining Of Time Series Data,” Docket No. DE9-2001-0041, filed on Dec. 21, 2001, and which is incorporated herein by reference in its entirety.

### FIELD OF THE INVENTION

The present invention relates to computer based data analysis, and in particular to a computerized method and system for detecting data subsequences in one or more numerical data series, to be identical or similar to a given search pattern.

### BACKGROUND OF THE INVENTION

A computerised data analysis method for detecting data subsequences in numerical data series, to be identical or similar to a given search pattern is disclosed in Agraval, R. et al., “Querying Shapes of Histories”, in Proceedings of the 21^{st} VLDB conference, Zurich, Switzerland 1995. A shape definition language, referred to as SDL is presented for retrieving “objects” based on shapes contained in the histories associated with these objects. The term object is used in the context of a database. Thus, with each object a set of sequences of real values is associated. Such sequences are referred therein as “histories”. Thus, the term “history” can be considered as one meaning for the term “pattern” which is used herein.

This approach uses an alphabet for describing the shape of a graphical representation of such history, as for example by using the alphabet element ‘appears’ for a transition from a zero value to a non-zero value. Or, the term “up” for describing a slightly increasing transition. Thus, by using a complex alphabet of definition terms a quite complex variety of geometrical shapes in a history can be described. Further, a set of operators, as for example a concatenation operator or an “exact” operator or an ‘at least’ operator, etc. is offered to define complex queries for a particular query of any desired shape in a history, or, for example a repetitive occurrence of the shape in the underlying data series.

One disadvantage of this approach, however, is the lack of flexibility when designing some shape definition to be searched. This is because the shape definition language is just offering a fixed set of definition elements for building up a given search criterion. Whenever individually selected details of the search pattern should be added to the definition of similarity which is used to define the ‘hit’ criterion, a respective number of detailed expressions must be added, always based on elements present in the shape definition language. This, however, is a very laborious procedure, in particular for those cases in which a search pattern has a quite complex geometrical shape.

Another disadvantage is that a first program is used for implementing the search definition interface and a second program will be used for visualising the search results. Thus, no intermediate search results are presented to the user for correcting or amending the search pattern definition, i.e., the definition of similarity. As a result, a fine, elaborated search strategy is very burdensome in particular, when the data series in use are very large, as it is often the case, for example when historical stock exchange data is analysed. In particular, a stepwise, quick and iteratively performed search with a respective interactively redefined similarity is not possible with this approach.

### SUMMARY OF THE PRESENT INVENTION

It is thus an object of the present invention to provide a computerized method and system for detecting data subsequences in one or more numerical data series, to be identical or similar to a search pattern, in which method a similarity model is defined yielding distance parameters for a query on said data series for deciding if a detected subsequence is similar or not.

The foregoing and other features and advantages of the present invention are realized by a method that presents a graphical representation of at least parts of said data series; that provides a user-interface for marking one or more subsidiary search patterns; that allows a user to visually observing the data series being presented; that redefines the distance parameters by including the subsidiary search patterns into a current definition of similarity; that presents a search result; and that provides an user-interface for initiating a repeated running of the previous steps.

According to this method, a search pattern may, for example be a data subsequence which is part of the original data series under analysis, or, it may be defined either graphically or by creating a respective numerical data subsequence. Thus, the term “pattern” is used in here for describing preferably the graphical representation of any given data sequence, as for example the sequence of:

2, 7, 14, 10, 8, 3, −1, −5, 0, 4,

in dependence of x-co-ordinates with any predetermined step size between the single data values.

One aspect of the present invention is thus to allow a user to define some search pattern from a graphical representation of at least a part of the data series or by a self-edited creation, and to define or redefine, interactively the currently used definition of similarity when the procedure will be iterated.

Advantageously, any suitable known, or available similarity model may be used for data analysis after having defined the distance parameters used by the similarity model, in a graphical way. Thus, for example the user may interactively select a certain range of the original data series and may mark it simply as a search pattern.

Then, the underlying data subsequence is converted by the present system into the specific form required by any selected similarity model in use. When for example the similarity model uses the so-called ‘primitive distance’ i.e., the distance between a respective pair Y1, Y2 of data of search pattern and data series under analysis, this conversion step is relatively simple because it is implemented according to the equation:

distance=|Y1−Y2|.

According to a preferred embodiment of the present invention, the user may run a search with the given search pattern, possibly covering only a subset of the original data series. Especially when the data series is quite large, the user may first watch the graphical representation of the search result and may then redefine the similarity definition by including one or more subsidiary search patterns that he visually detected, either in the original data series or in the search result, before the explores the complete original data series.

Furthermore, this procedure can be done iteratively while the user takes profit of the close feedback obtained by observing the immediate effects of a preceding change in the similarity definition. In addition, the user may exclude selected subsidiary patterns associated with any preceding pattern selection in order to modify his search strategy.

Thus, the search patterns may simply be marked with the help of a mouse or another input device.

Moreover, the search result presented by the present data analysis system comprises the graphical representation of detected patters, along with a respective scaleable data series context embedding the detected data subsequences. Thus, the user may observe the immediate environment of the detected subsequences and may learn about the underlying data series.

According to another aspect the present method, a user interface establishes a new query by combining patterns with logical operators, such as AND, OR, NOT, etc. Accordingly, the foregoing conversion step for adapting the similarity model to the respective similarity definition will be done.

When for example the logical OR-operator is used, it may be implemented by performing the search a first time with the first operand of the OR, followed by a second run based on the second operand as a search criterion. If an AND-operator is used, this will correspondingly be done within a single search run with a respectively amended similarity definition.

In addition, a user interface is provided for defining a predetermined sequence of search patterns as a part of the similarity definition. Thus, a user may for example specify that a first search pattern, marked by the user must be followed by a second search pattern, possibly also marked by the user after a predetermined pattern separation interval in order to define a hit of the search. Thus, the user search tool box is further extended.

Further, the present method may additionally comprise the step of presenting a numerical, editable representation of a pattern, and the step of including user-edited pattern changes into the similarity definition.

Thus, for example the user may produce a search pattern simply by changing only a single number of the numerical representation of a pattern. Further, the user may pick a detected subsequence and may edit it graphically with the mouse in order to generate an individual search pattern.

Moreover, the present method preferably implements a plurality of similarity model algorithms and a respective user interface for selecting one of similarity model algorithms for any particular search.

A preferential business application of the present method is to analyse time-dependant data series, i.e., time series, as for example historical stock exchange data. Thus, the present method may also be incorporated within a program for predicting future behaviour of share prices, share indexes, or similar data.

Further, when the present method comprises the step of calculating a pattern, i.e., an ‘ideal hit signature’ by calculating a selected, conditioned average over the collected hit patterns and displaying the ideal hit signature subsequently, then the user may have a visual impression of an archetype of his currently valid similarity definition selected for the user's search. Such an archetype search pattern can for example advantageously be applied for classifying a particular search for search documentation purposes.

The present method may also be used after a preparation procedure has taken place on a given content of information that is not represented originally as numerical data series. An example might be genome sequences. A further example is when the original data is not of numerical nature, but instead, it is essentially comprised of characters. Then the present method can be used for text analysis.

The preparation then encodes the characters according to a given, predetermined mapping rule which maps each character to a specific number. For example ‘a’ is mapped to 1, ‘b’ is mapped to 2, ‘c’ is mapped to 3, and so forth. It is therefore clear that other mapping rules may also be used. For example, a set of more meaningful rules which generates small-distance value differences for very usual sequences of characters, such as in the English language the character sequence ‘in’, ‘ng’, ‘nd’, or ‘ea’, ‘sp’, and the like, and larger differences for more rare character sequences, such as example ‘kl’ in the word ‘sprinkler’, or ‘mf’, or ‘pt’. The encoded sequence may comprise up-trends or down trends, that are intentionally introduced as required, in order to avoid the curve to depart too much from any Y-axis reference line, e.g., the Y=0 line.

Further, the search results can be correspondingly decoded in order to be transformed into patterns of text, by applying the inverse mapping rules. The steps of encoding and decoding may be part of the present system or they can be a separate module that may be invoked by the user within a given analysis tool.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic representation illustrating a preferred multiple layer program structure or system according to a preferred embodiment of the present invention;

FIG. 2 is a flow chart representing a control flow operation of the program structure of FIG. 1; and

FIG. 3, FIG. 4, FIG. 5, and FIG. 6 are schematic representations illustrating exemplary reference patterns generated by the present program structure and method of FIGS. 1 and 2.

### DETAILED DESCRIPTION OF PREFERRED EMBODIMENTS

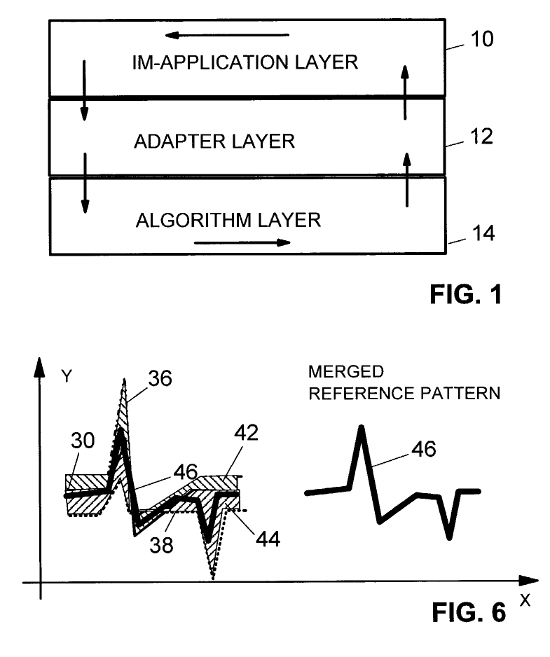

FIG. 1 illustrates a preferred implementation of the present system or computer program product. This present system comprises a three-layer-arrangement having a first application layer 10, an underlying adapter layer 12 and an algorithm layer 14 at the bottom.

The application layer 10 comprises all program logic needed for establishing the user interface for the process of interactive data mining. Thus, layer 10 is also referred to as Interactive Mining (IM) layer, too. Thus, IM-layer 10 comprises in particular the graphical user interface containing the graphical representation of data series, of selectable data sequences, of query results and all program logic needed to implement the criteria comprising the user-defined definition of similarity as a base for the data queries.

The adapter layer 12 includes essentially the control logic needed to process the user input to generate adequate program parameters for the underlying algorithm layer 14. Thus, the adapter layer 12 acts as an interface and control layer as compared to conventional similarity model algorithms that are used for analysing a given amount of mass data.

Thus, the adapter layer 12 comprises the control logic needed for transforming the user input into the formal parameters required by one or more query algorithms of the algorithm layer 14. A feature of the adapter layer 12 is to check the user input data for conflicts that may arise when the user defines a similarity criterion which is ambiguous or contradictory. In other terms, the output of adapter layer 12 is consistent with the input requirements of the underlying algorithm layer 14.

The algorithm layer 14 provides one or more data query algorithms capable of analyzing the underlying data with individual search criteria successfully.

Such a multiple, preferably a three-layer structure provides for improved modularity and universal use of prior art data analysis algorithms. Further, the modularity allows for easy integration into existing application programs.

More details of the program logic used in the above-mentioned layers 10, 12 and 14 are described and can be derived from the following description of the basic control flow which is run through during an exemplary “Interactive Mining” user session.

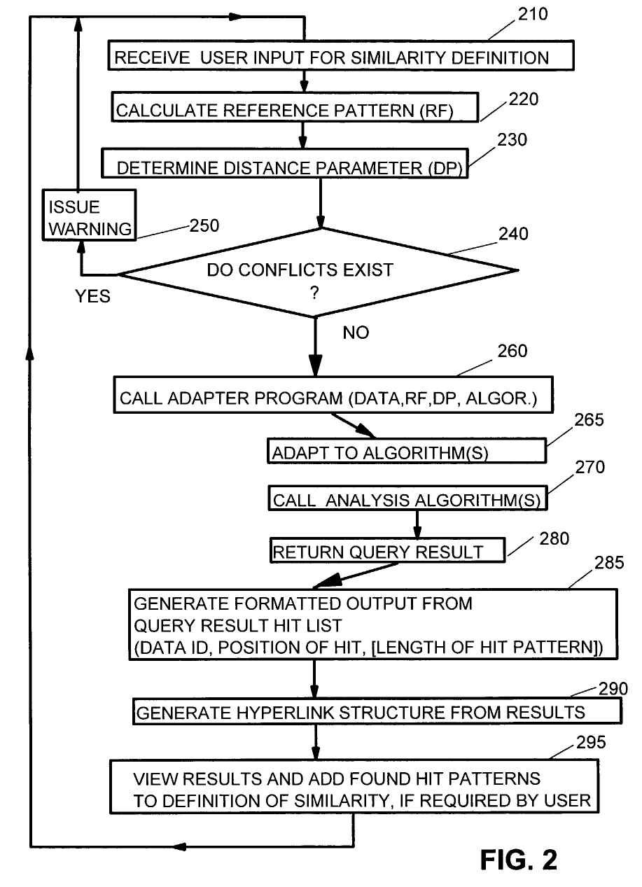

With further reference to FIG. 2, it is assumed that the user is provided with a personal computer and runs the present multi-layered (i.e., three-layered) system of FIG. 1. It is further assumed that the underlying mass data to be analysed can be accessed from the user PC. The underlying data may be, for instance, stock exchange data, such as a chart of a given share A, a given share B, and a share C, with the mass data comprising historical stock market charts of the market indices.

The exemplary business goal the user is attempting to find out chart similarities or contexts between the market charts and those of the shares A, B, and C. The user looks for evidence from historical data used to support some theory, such as saying that share B has often chart sections similarly formed as that of share A, but delayed, for example by an average delay of three days. Another exemplary theory might be the object of the user session.

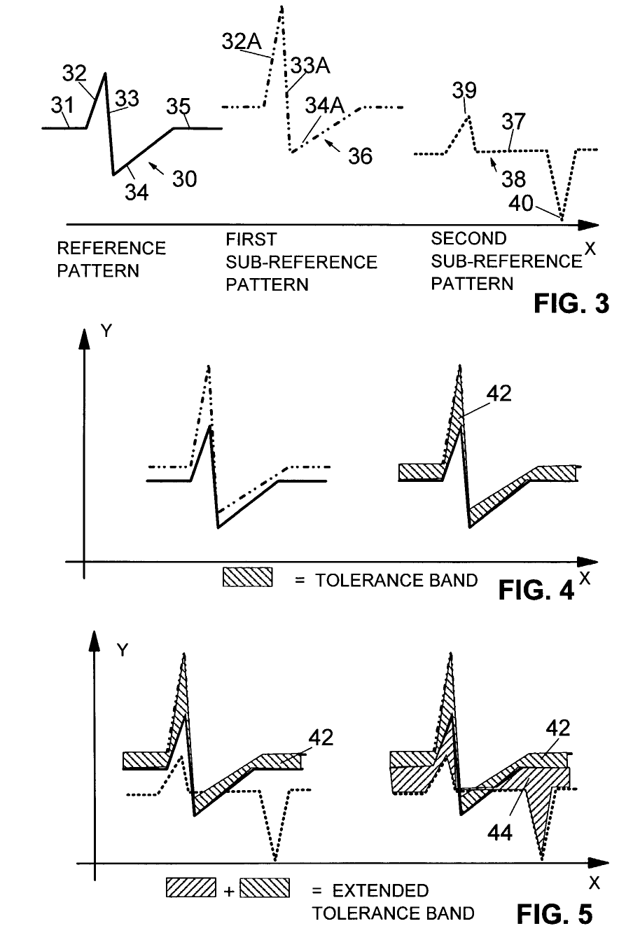

In order to prove this theory and knowing that the charts of A and B show a lot of individual differences between each other the user decides to pick some significant chart subsection in the chart of share A which the user hopes to find multiply repeated in the chart of A and with some context empirically to be found—to be repeated in the chart of share B. Such subsections are exemplarily depicted in FIGS. 3, 4, 5, and 6.

According to the present invention, the user is now able to select graphically some significant subsection of, for example chart A which is displayed in one window at the user desktop PC. The user defines a rectangle with the mouse which selects a desired chart subsection which will be further used as the reference pattern intended to be repeatedly found in either the charts of A and B. Such reference pattern is depicted exemplarily in FIG. 3, left margin.

In order to find similar patterns a similarity definition must be established to distinguish between a hit pattern and the rest of no-hit patterns. This is done in step 210 of FIG. 2. An example for a similarity criterion is to take the so-called “primitive distance” as it was mentioned above. The formula for distance D is as follows:

|Yᵢ−Yrefᵢ|≦D,

where “i” is a variable covering the quantity of data within the value sequence constituting the reference pattern, or any pattern which is compared for similarity in either the charts of share A and B. For example, “i” may be in the range between 0 and 50. The distinct values are not depicted in the drawings in order to keep them simple and clear.

Thus, in step 220 the reference pattern referred (RF) is calculated by extracting it from the underlying mass data of share A. Thus, the reference pattern is defined as a reference sequence of values. This reference sequence is now stored separately by the program in a way which allows for comparing it with the data of chart B preferably such that only the shape of the reference pattern is used for comparison, i.e., explicitly not including the absolute position in the Y-axis. This is done in order to concentrate on finding shape similarity in the charts.

Then, in step 230, the distance parameter (DP) is input by the user as, for example DP=10, which is assumed to be a meaningful input with reference to the given chart comparison.

Then, at decision step 240, the similarity definition is checked for conflicts, which might arise, for example when the parameter D is selected too small or too large such that the data analysis would not make sense. If a conflict exists, a respective warning is issued in step 250 to the user. Then the method returns to step 210 in order to allow the user to redefine the similarity definition. In at decision step 240 no conflict is found to exit, the method proceeds to step 260. Steps 210 to 240 are basically implemented within IM-layer 10 of FIG. 1.

In step 260, the adapter control program is called with a pointer to the target data intended to be analysed, a pointer to the reference data sequence, and the value of the distance parameter DP. In the event more than one search algorithm can be selected by the user, a further pointer is included which references the desired search algorithm.

In step 265 the adapter control program receives the transferred parameters and transforms them into any specific form which is required by the one or more selected query algorithms. This transformation may be readily programmed.

Then the search algorithm is called in step 270, with adequate parameters. Such algorithm sequentially searches the desired mass data, i.e., the charts of share A and B and compares in each step the data with the reference pattern. If a hit is found, i.e., similarity is determined to be present for a given subsection, this hit pattern or hit subsection is marked and copied to some extra buffer including the start- and end-position of it.

In the event of a hit, the sequential search is continued after the end-position of the hit pattern, else it is continued at a next position advanced from the former start-position by a predetermined delta value, which may be optionally be input by the user in order to influence the duration of data analysis.

Then, in step 280, the query result is returned to the adapter program 12.

According to a preferred embodiment of the adapter program, a formatted output is generated, in step 285, from the query result hit list, which basically comprises the above-mentioned hit patterns from either of the analysed mass data. Each hit pattern basically comprises identifications for the source data it is originated from, the position within the source data and optionally the length of it, or the end-position, respectively.

According to another feature of the present embodiment, at step 290, the adapter control logic generates a hyper link structure from the search result of each mass data that connects the hit patterns by pointers and enables for an easy reviewing of the found hit patterns in the mass data itself in a separate window within the user interface of the IM-layer 10.

Thus, the user is enabled to have an intuitive impression where the hit patterns are located in the source data, how they are distanced from each other and in what Y-position a hit pattern is found. Preferably this review is offered in all mass data under analysis, in parallel in either separate windows or the same window. Thus, the user may easily be confirmed of a given theory and is supported with evidence thereon, or the contrary case is given in which no essential, significant evidence could be found in the analysed mass data.

Optionally, according to another feature of the present invention, the user may graphically select, with a mouse or another input or pointing device, one of the found hit patterns, and may include it into a given definition of similarity. The definition is stored separately, and may be named with a significant variable name in order to be reused in a further session (step 295).

The foregoing description comprises an example in which a single reference pattern was used as a part of the similarity definition. As it will be described later, another feature of the present invention will be explained in more detail, which enables for more than one reference patterns to be included in the definition of similarity.

With reference to step 295, the user is assumed now to select a given hit pattern found during a first analysis run into the current definition of similarity which was used in said analysis run. This feature will be explained in an example in which two additional hit patterns will be included into the definition of similarity. With reference to FIGS. 3 through 6, the additional two hit patterns are referred to as first and second sub-reference patterns. They are depicted in FIG. 3, in the middle position and right position, respectively.

The underlying exemplary user motivation for extending the similarity definition is assumed in that the user will be able to modify the user's work intuitively, driven by the visual impression that the user has when the user views the found hit patterns. In this way, the user is enabled to recognise archetypes of patterns which may be selectively seen as somehow characteristic for a given mass data type, such as for share A.

In FIG. 3, the original reference pattern depicted at the left position comprises in particular a first constant section 31, a subsequent rising edge 32, a subsequent falling edge 33 that is followed by a further rising edge 34, which, in turn, is followed by a last constant section 35. The slope of the rising edge 32 is assumed to be greater than that of the rising edge 34 in order to be found characteristic for an inclusion into the similarity definition.

The first sub-reference pattern depicted with reference sign 36 is generally similar to reference pattern 30, but is assumed to comprise a more inclined rising edge 32A, a more inclined (negatively) falling edge 33A, as well as a less inclined second rising edge 34A, compared to reference pattern 30.

The second sub-reference pattern is denoted with 38 and is characterised by a constant delay 37 as a separation between a first local maximum 39 and a second local minimum 40, in correspondence to the shape of patterns 30 and 36, respectively. According to a preferred feature of the present invention, a way is presented in which a tolerance band is defined between one or more reference patterns which is used in addition or in modification of the constant parameter “primitive distance D” as presented earlier.

FIG. 4 illustrates a sub-reference pattern 36 that is overlaid on, i.e., superposed on reference pattern 30, explicitly taking into account that reference pattern 36 has a certain Y-position which is located higher than that of reference pattern 30. Both patterns define an area that lies therebetween, having a given outline. This area is shown as being cross-hatched, and represents the tolerance band used for the new similarity definition for the next analysis run, when the steps depicted in FIG. 2 are repeated, as this is depicted with the arrow connecting step 295 and step 210.

It should be noted that a distance criterion is also used for determining similarity, but said distance is variable dependent of x, i.e., the position within the pattern. The tolerance band is depicted in FIG. 4, right position, with reference sign 42. A person skilled in the art will appreciate that the patterns that are found as hit patterns comply with the tolerance band, i.e., that are located graphically within the hatched area 42. Thus, very characteristic patterns can be found in the underlying data.

With reference to FIG. 5 the user is assumed to extend the similarity definition from FIG. 4 by inclusion of the second sub-reference pattern 38 depicted in FIG. 3, right position. This could be, for example in a situation which guided the user to do so when the user realises that the delay section 37 is found to be an empirically proved fact, for which what ever explanation might exist.

Thus, the intention of the user is to extend the tolerance band in order to capture additional hit patterns for proving the underlying theory. According to a preferred embodiment of the present invention, the similarity definition is extended again, by overlying all three patterns 30, 36 and 38, as depicted in FIG. 5, position, without inclusion of pattern 38 and after inclusion, right position. A new overall outline results as a definition of the tolerance band. The additional tolerance band is depicted with reference sign 44. Its hatching structure is represented inverse to that of area 42. Thus, the extended tolerance band is the union, i.e., the combined area of areas 42 and 44.

Referring now to FIG. 6, it illustrates an alternative way according to the present invention: instead of extending the tolerance band by establishing an union of areas the reference patterns are merged to yield a merged reference pattern.

As it is depicted in FIG. 6 the three patterns 30, 36 and 38 are overlaid, i.e., superposed, as illustrated in the left position of FIG. 6. In a second step, however, a merged pattern is built up as a “thick line” that has a definite width to be determined by the user and which connects points that are found to be the arithmetic mean, set-up for each x-value, or l value, respectively.

Thus, an area centre line is set-up with a given width. The width can be varied by the user within some useful limits, which are preferably checked in decision 240, as described earlier. The advantage of a merged reference pattern is that this is a way in which a large number of hit patterns can be included into a current definition of similarity without an extended amount of calculations being necessary.

In the foregoing specification the present invention has been described with reference to a specific exemplary embodiment thereof. It will, however, be evident that various modifications and changes may be made thereto without departing from the spirit and scope of the present invention.

The present method may be used in combination with known or available data mining tools. As an example, an add-on component is provided that basically comprises the interactive mining application layer 10 and the adapter layer 12, only in order to make the user profit from the intuitive adaptation and extension of the similarity criterion. Further, it should be noted that when the definition of similarity comprises the exclusion of any given pattern or the exclusion of a given exclusion tolerance band then, the conflict decision step 240 of FIG. 2, should be enhanced in order to maintain consistency.

The present invention can be implemented in hardware, software, or a combination of hardware and software. An interactive data mining tool according to the present invention can be realised in a centralised fashion in one computer system, or in a distributed fashion where different elements are spread across several interconnected computer systems. The present invention can also be embedded in a computer program product.

What is claimed is:

1. A method for detecting data subsequences in at least one numerical data sequence, with the data subsequences being comparable to a search pattern, comprising:
presenting a graphical representation of the at least one numerical data sequence;
marking at least one subsidiary search pattern;
redefining distance parameters by including the at least one subsidiary search pattern into a similarity definition; and
presenting a search result.

2. The method according to claim 1, wherein redefining the distance parameters comprises:
superposing shapes contained in the at least one subsidiary search pattern; and
defining an extended tolerance band for outlines resulting from the shapes that have been superposed.

3. The method according to claim 1, wherein redefining the distance parameters comprises:
superposing shapes contained in the at least one subsidiary search pattern; and
defining a merged reference pattern by a centre line area of the shapes that have been superposed, wherein the centre line area has a predetermined width.

4. The method according to claim 1, wherein the search result comprises a graphical representation of a detected subsidiary search pattern, along with a respective scaleable data sequence context.

5. The method according to claim 1, further comprising providing a user-interface for marking the at least one subsidiary search pattern from the search result.

6. The method according to claim 1, further comprising providing a user-interface for establishing a new query by combining the at least one subsidiary search pattern with logical operators.

7. The method according to claim 1, further comprising providing a user-interface for defining a predetermined sequence of search patterns as part of the similarity definition.

8. The method according to claim 1, further comprising presenting a numerical, editable representation of a subsidiary search pattern, and including user-edited pattern changes into the similarity definition.

9. The method according to claim 1, further comprising providing a user-interface for selecting one of a plurality of similarity model algorithms.

10. The method according to claim 1, wherein detecting the data subsequences comprises using a multiple layer structure.

11. The method according to claim 10, wherein the multiple layer structure comprises an application layer that provides a user interface means; an algorithm layer that provides at least one data analysis algorithm; and an adapter layer that acts as an interface between the application layer and the algorithm layer.

12. The method according to claim 1, wherein the data sequence comprises a time series.

13. The method according to claim 1 that is used for analyzing non-numerical data series, further comprising:
encoding the non-numerical data series according to a predetermined mapping scheme into numerical data;
decoding the numerical data after analysis into the original data format; and
applying a reverse mapping scheme.

14. The method according to claim 13, wherein analyzing non-numerical data series comprises processing any one or more of genome data and text data.

15. The method according to claim 1, further comprising calculating an ideal hit signature by calculating an average over collected hit patterns; and
displaying the ideal hit signature.

16. A computer program product having instruction codes for detecting data subsequences in at least one numerical data sequence, with the data subsequences being comparable to a search pattern, comprising:
a first set of instruction codes for presenting a graphical representation of the at least one numerical data sequence;
a second set of instruction codes for marking at least one subsidiary search pattern;
a third set of instruction codes for redefining distance parameters by including the at least one subsidiary search pattern into a similarity definition; and
a fourth set of instruction codes for presenting a search result.

17. The computer program product according to claim 16, wherein the third set of instruction codes for redefining the distance parameters superposes shapes contained in the at least one subsidiary search pattern, and defines an extended tolerance band for outlines resulting from the shapes that have been superposed.

18. The computer program product according to claim 16, wherein the third set of instruction codes for redefining the distance parameters superposes shapes contained in the at least one subsidiary search pattern, and defines a merged reference pattern by a centre line area of the shapes that have been superposed, wherein the centre line area has a predetermined width.

19. The computer program product according to claim 16, wherein the search result comprises a graphical representation of a detected subsidiary search pattern, along with a respective scaleable data sequence context.

20. The computer program product according to claim 16, further comprising a user-interface for marking the at least one subsidiary search pattern from the search result.

21. The computer program product according to claim 16, further comprising a user-interface for establishing a new query by combining the at least one subsidiary search pattern with logical operators.

22. The computer program product according to claim 16, further comprising a user-interface for defining a predetermined sequence of search patterns as part of the similarity definition.

23. The computer program product according to claim 16, further comprising a numerical, editable representation of a subsidiary search pattern, and including user-edited pattern changes into the similarity definition.

24. The computer program product according to claim 16, further comprising a user-interface for selecting one of a plurality of similarity model algorithms.

25. The computer program product according to claim 16, comprised of a multiple layer structure; and
wherein the multiple layer structure comprises an application layer that provides a user interface means; an algorithm layer that provides at least one data analysis algorithm; and an adapter layer that acts as an interface between the application layer and the algorithm layer.

26. A system for detecting data subsequences in at least one numerical data sequence, with the data subsequences being comparable to a search pattern, comprising:
means for presenting a graphical representation of the at least one numerical data sequence;
means for marking at least one subsidiary search pattern;
means for redefining distance parameters by including the at least one subsidiary search pattern into a similarity definition; and
means for presenting a search result.

27. The system according to claim 26, wherein the means for redefining the distance parameters superposes shapes contained in the at least one subsidiary search pattern, and defines an extended tolerance band for outlines resulting from the shapes that have been superposed.

28. The system according to claim 26, wherein the means for redefining the distance parameters superposes shapes contained in the at least one subsidiary search pattern, and defines a merged reference pattern by a centre line area of the shapes that have been superposed, wherein the centre line area has a predetermined width.

29. The system according to claim 26, wherein the search result comprises a graphical representation of a detected subsidiary search pattern, along with a respective scaleable data sequence context.

30. The system according to claim 26, wherein the multiple layer structure comprises an application layer that provides a user interface means; an algorithm layer that provides at least one data analysis algorithm; and an adapter layer that acts as an interface between the application layer and the algorithm layer.
